(19) United States
(12) Patent Application Publication
(10) Pub. No.: US 2006/0260766 A1
(43) Pub. Date: Nov. 23, 2006

(54) High velocity category 5 accordion shutter system

(76) Inventors: Humayuon Farooq, Miami, FL (US); Steve Camposano, Naples, FL (US)

Correspondence Address: Robert M. Downey, Esq.;Ste. 300, 601 S. Federal Hwy., Boca Raton, FL, 33432, US

(21) Appl. No.: 11/133,840

(22) Filed: May 19, 2005

(51) Int. Cl. E06B 3/48

(52) U.S. Cl. 160/183

(57) ABSTRACT

An accordion shutter system has a folding arrangement of interconnected slats moveably supported on a track assembly. The track assembly includes an overhead header with longitudinal rails on opposite sides of a central gap and outboard abutment surfaces. The track assembly further includes a lower floor track extending parallel with the header along the same plane and having a guide slot arranged in opposing relation to the gap in the header. The slats extend vertically between the header and floor track and are each rotatable about a vertical axis defined at the interconnection of male end and female end fittings of adjacently positioned slats. Trolleys are captivated within the header and have opposite wheels for rolling travel along the rails. Each trolley connects to the center of a correspondingly positioned slat to support the slat vertically between the header and floor track and to permit evenly balanced horizontal and folding movement of the folding slat arrangement between a fully open position and a closed position to protectively cover a door, window or other building structure.

### BACKGROUND OF THE INVENTION

1. Field of the Invention

The present invention relates to hurricane shutter systems and, more particular, to accordion shutter systems which use a plurality of vertically oriented slat members movable along a track system in a folding and unfolding action.

2. Discussion of the Related Art

Hurricane shutters and panels of various type are well known, particularly in areas which are regularly subjected to the threat of tropical storms and hurricanes. Storm shutters and panels are typically used to protect windows, doors and other vulnerable structure from the force of high winds and flying objects. Many coastal areas have now enacted building codes modeled after the building code of Dade County, Florida, which require storm shutters and panels to withstand specific levels of wind force and degrees of deflection caused by flying objects hitting the panels or shutters.

Storm shutters provide the added convenience of deployment with the use of interconnecting slats or blade portions which rotate relative to one another when moved along a guide track. The two primary types of storm shutters are generally categorized as roll-up shutters and accordion or folding shutters. Roll-up shutters typically move vertically up and down relative to a window or door opening and wrap about a central winding axis, in a roll form, when moved to the open or stowed position. Accordion shutters on the other hand, typically move horizontally relative to a door or window opening along a header and sill or base track. The slats of accordion shutters are arranged in a generally zig zag formation and stack upon one another, in a fan folded arrangement, when moved open to the side(s) of the door or window.

While most of the accordion shutter systems presently available on the market do comply with building code requirements, they are, for the most part, bulky and difficult to operate. In particular, accordion shutters tend to bind or jam when pulled along their tracks. This is generally due to the weight of the slats coupled with the friction resulting from uneven balance (off-center) of the slats as they are moved along the track system. A further problem is encountered when attempting to install and deploy accordion shutters about a curved structure. Most track structures in accordion shutter systems are manufactured straight and are not suitable for bending about a curve. Moreover, the uneven balance of the slats makes it extremely difficult to move the interconnecting and folding slats about a curved track.

Accordingly, there remains a need in the storm shutter industry for an accordion shutter system which is designed to balance the load in the center of the track for easier movement, without binding or jamming, and further wherein the tracks are designed for ease of curving to permit installation about a non-linear structure.

### SUMMARY OF THE INVENTION

The accordion shutter system of the present invention is directed to a system which has a folding arrangement of interconnected slats moveably supported on a track assembly. The track assembly includes an overhead header with longitudinal rails on opposite sides of a central gap and outboard abutment surfaces. The track assembly further includes a lower floor track extending parallel with the header along the same plane and having a guide slot arranged in opposing relation to the gap in the header. The slats extend vertically between the header and floor track and are each rotatable about a vertical axis defined at the interconnection of male end and female end fittings of adjacently positioned slats. Trolleys are captivated within the header and have opposite wheels for rolling travel along the rails. Each trolley connects to the center of a correspondingly positioned slat to support the slat vertically between the header and floor track and to permit evenly balanced horizontal and folding movement of the folding slat arrangement between a fully open position and a closed position to protectively cover a door, window or other building structure. The accordion shutter system is structured to withstand high velocity winds in a category 5 hurricane.

### BRIEF DESCRIPTION OF THE DRAWINGS

For a fuller understanding of the nature of the present invention, reference should be made to the following detailed description taken in conjunction with the accompanying drawings in which:

FIG. 1 is cross-sectional view, interrupted at the center to reduce the height of the view, illustrating installation of the accordion shutter system of the present invention between an overhead structure and floor or base structure of a building;

FIG. 2 is an isolated cross-sectional view of a lower portion of the accordion shutter system of the present invention, illustrating adjusted mounting of a floor track of the system to an expansion base to accommodate for variations in height and slope between the overhead structure and floor structure of the building to which the accordion shutter system is installed;

FIG. 3 is a top plan view, in partial cross-section, of the accordion shutter system taken below the header along the plain of the aligned 3-3 in FIG. 1;

FIG. 4 is an isolated top plan view of an end base member;

FIG. 5 is an isolated top plan view of a starter slat;

FIG. 6 is an isolated top plan view of a full slat;

FIG. 7 is an isolated top plan view of a right side center mate of the slate mating structure of the accordion shutter system;

FIG. 8 is an isolated top plan view of a left side center mate of the slat mating structure for cooperative and releasable interconnection with the right side center mate to secure left and right extensions of the accordion shutter system pulled closed;

FIG. 9 is a side elevational view of the header forming a portion of the track of the accordion shutter system;

FIG. 10 is an exploded side elevational view showing the floor track and expansion base forming a lower portion of the track of the accordion shutter system; and

FIG. 11 is a side elevational view of an optional base plate used for mounting the floor track and expansion base to the underlying floor surface of the building structure.

Like reference numerals refer to like parts throughout the several views of the drawings.

### DETAILED DESCRIPTION OF THE PREFERRED EMBODIMENTS

The accordion shutter system and the component parts thereof are shown throughout the several views of the drawings, wherein the accordion shutter system is generally indicated as 10.

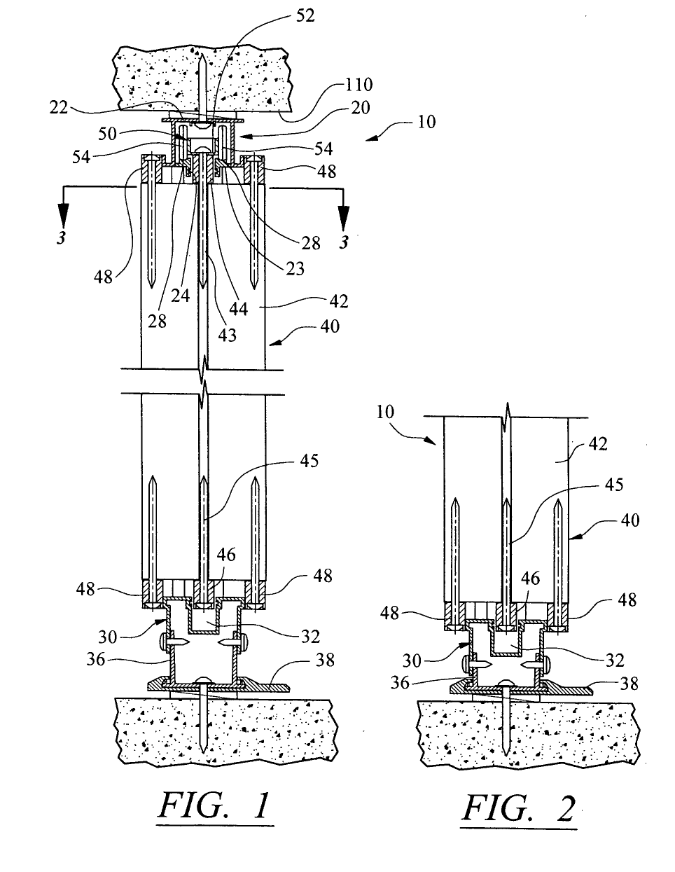

Referring initially to FIGS. 1 and 2, the accordion shutter system 10 includes an elongate header 20, an elongate floor track 30 and a folding shutter slat arrangement 40 extending vertically between the header and floor track and suspended on a plurality of trolleys 50 movably disposed within the header.

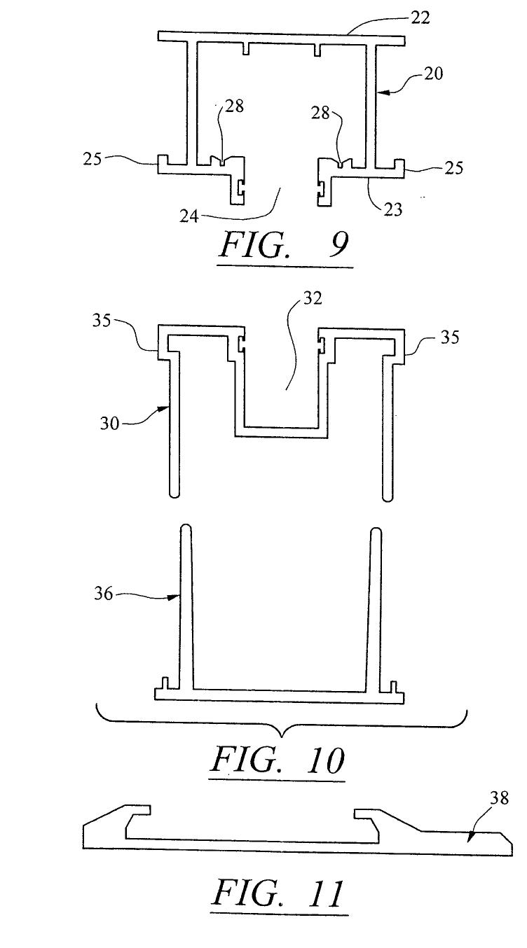

With further reference to FIG. 9, the header 20 is shown to include a top plate member 22 which mounts to an overhead structure 110 with the use of conventional fasteners, such as TAPCON screws. The header 20 further includes a lower side 23 with a central elongate gap 24 and upturned wing members forming outer rail surfaces 25 on opposite sides of the header. The outer rail surfaces 25 and central gap run 24 the length of the header. A track is formed within the header and also runs the entire length of the header. The track is defined by rails 28 on opposite sides of the gap 24.

The plurality of slats forming the interconnected folding slat arrangement 40 are supported by a plurality of trolleys 50 movably disposed within the header. Each trolley 50 includes a center carriage 52 and opposite wheels 54 rotatably guided along the rails 28 of the track, thereby permitting travel of the trolleys along the length of the track in the header. The carriage 52 of each trolley is connected to a corresponding slat member 42, to support the slat member in hanging relation to the header so that the slat member extends between the header 20 and floor track 30. More specifically, a pin 43 or like fastener connects between the carriage of the trolley and the top end of a respective one of the slat members, with the pin connecting approximately at the mid point along the top edge of the slat member. A bushing 44 is provided between the top end of the slat member and the underside of the carriage of the trolley to provide spacing and rotation of the respective slat member relative to the trolley.

The floor track 30 is provided with an elongate central guide slot 32 extending along the entire length of the floor track. The guide slot 32 is positioned in parallel, vertical alignment with the gap 24 of the header 20. A guide pin 45 with bushing 46 is attached to the bottom center of each slat member for guided receipt and travel along the guide slot 32 of the floor track 30. Like the attachment of the top end of each slat member 42 to the respective trolleys 50, the guide pins 45 are centered on the lower end of each of the respective slat members so that the slat members are balanced on center between the gap 24 of the header 20 and the guide slot 32 of the floor track 30.

To further maintain center balance and guided travel of the interconnected, folding slat arrangement, contact bushings 48 are fitted to the interconnection points between adjacent slat members, on both the top and bottom ends. The contact bushings are specifically structured for engagement with the outer abutment surfaces of both the header and floor track. More specifically, bushings 48 on the top ends of the respective slat members engage the opposite outboard rail surfaces 25 of the header, while the contact bushings 48 on the lower ends of the respective slat members are disposed in abutting engagement with outboard side surfaces 35 of the floor track 30.

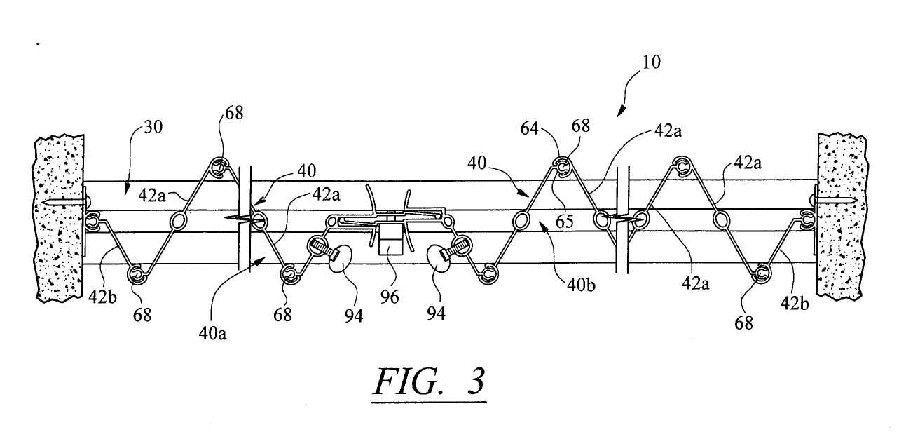

Referring now to FIGS. 3-8, the folding arrangement 40 of interconnecting slats 42 is shown. Specifically, the slats 42 are comprised of a plurality of full slat members 42a, as shown in FIG. 6, and starter slat members 42b, as seen in FIG. 5. Both the full flat members 42a and the starter slat members 42b include opposite ends 60,62, with one end having a generally C-shaped female fitting 64 and the opposite end having a generally C-shaped male fitting 65. The male fittings 65 are specifically structured and configured for receipt within the female fitting 64 of a correspondingly positioned slat (either full slat or starter slat). As shown in FIG. 3, the combined attachment of the male end fitting 65 of one slat member with the female end fitting 64 of an adjacently positioned slat member forms a pin receiving channel 68 for receipt and attachment of the contact bushing 48, as described above. The female end fittings 64 and male end fittings 65 are provided with stop elements 70,72 respectively, at the open ends of the C-shaped configuration. These stop elements 70,72 serve to limit rotation of the interconnected male and female end fittings relative to one another about a vertical axis defined along the center of the pin receiving channel 68.

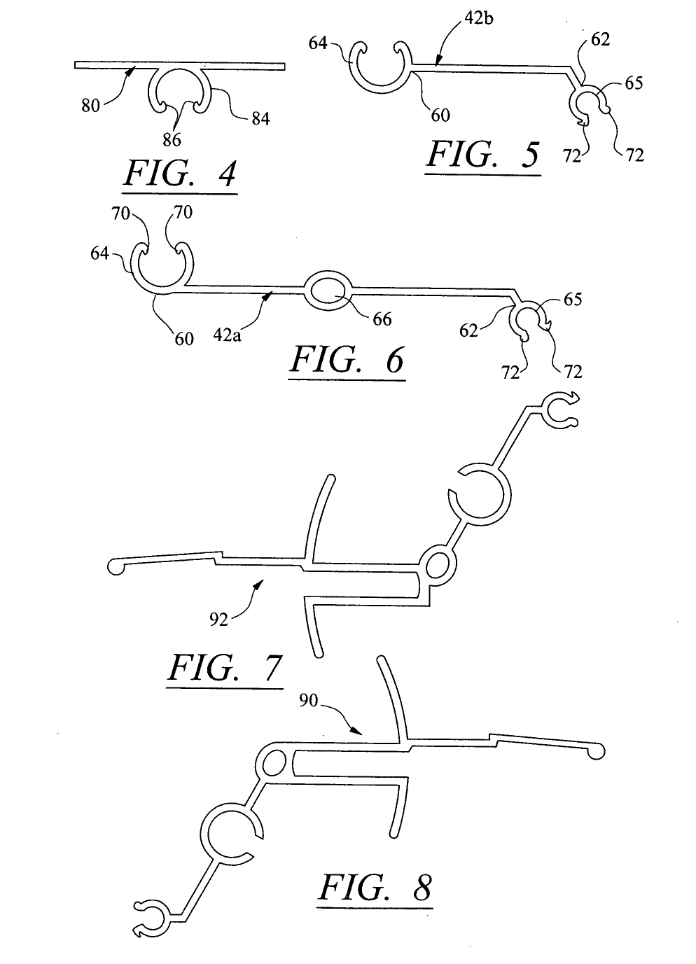

As seen in FIGS. 3 and 4, the male end fittings 65 on the starter slats 42b are rotatably fitted within a female fitting 84 of an end base 80 which is secured to the vertical wall surface of the building structure, at opposite ends of the folding slat arrangement. Similar to the interconnection of the male and female end fittings of adjacently positioned slat members (either full slat members or starter slat members) the female fitting 84 of the end base 80 is provided with stop elements 86 to limit rotation of the male end fitting 65 of the starter slat 42b within the female fitting 84 of the end base.

The full slat members 42a (FIG. 6) are provided with a centrally located center channel 66 which presents a pin receiving channel for attachment of the trolleys 50 at the upper end of the full slat members and the guide pin 45 and bushings 46 on the bottom end of the full slat members, as described above.

As shown in FIG. 3, the accordion shutter of the present invention is typically assembled to include left side interconnected arrangement of slat members 40a and a right side interconnected arrangement of slat members 40b. The left arrangement and right arrangement are pulled towards one another, along the track assembly, and are joined at their inboard ends to fully close the folding arrangement of slat members 40 in protected relation to a window, door or other structure. To facilitate secured attachment of the left and right arrangements 40a, 40b of slat members, a pair of center mates are provided. Specifically, a left side center mate 90 is structured to be joined with a right side center mate 92 to secure the folding arrangement of slats in the closed, fully deployed position, as seen in FIG. 3. To further secure the folding arrangement of slat members closed, thumb screws 94 and a plunger lock 96 are provided. The thumb screws 94 serve as set screws to secure locking bars within the track assembly. The plunger lock 96 serves to secure the left and right side center mates joined together.

As seen in FIGS. 1,2 and 10, the floor track 30 is secured to an expansion base 36 which mounts to an optional base plate 38 (see FIG. 11) or directly to substrate with the use of TAPCON screws or other fasteners. The floor track 30 can be adjustably positioned relative to the underlying floor surface with the use of the expansion base 36. Specifically, the floor track 30 can be adjustably positioned relative to the expansion base 36 to level the floor track, maintaining the floor track 30 parallel to the header 20 and level so that the guide pins 45 and bushings 46 on the bottom ends of the slat members are able to travel freely along the length of the guide slot 32 in the floor track 30.

While the instant invention has been shown and described in accordance with a preferred and practical embodiment thereof, it is recognized that departures from the instant disclosure are contemplated within the spirit and scope of the present invention.

What is claimed is:

1. An accordion shutter system comprising:
a folding slat arrangement including a plurality of interconnecting longitudinal slats each having a top end, a bottom end, a first longitudinal side extending between said top and bottom ends and an opposite second longitudinal side extending between said top and bottom ends;
a male fitting formed along said first longitudinal side;
a female fitting formed along said second longitudinal side;
said plurality of slats being moveably interconnected to one another by said male and female fittings, and said male fitting on each of said plurality of slats being structured and disposed for captured, rotating receipt within said female fitting of an adjacently positioned slat, and said male fitting and said female fitting including cooperating stop members for capturing said male fitting within said female fitting and for limiting rotational movement of said male fitting relative to said female fitting and thereby limiting folding movement of the interconnected slats relative to one another;
a track assembly including an upper header and a lower floor track extending parallel with said header along a common plane, said header including longitudinal rails on opposite sides of a central gap and said floor track including a guide slot arranged in opposing relation to said gap in said header;
a plurality of trolleys captivated within said header and having opposite wheels for rolling travel along said rails of said track assembly;
said plurality of slats being vertically arranged between said header and said floor track, and each of said trolleys being connected to the top end of one of said plurality of slats to support the folding slat arrangement in hanging relation to said header;
a central guide pin and bushing attached to the bottom end of each of said plurality of slats for guiding receipt within and travel along said guide slot of said floor track; and
said plurality of trolleys and said guide pins and bushings being cooperatively structured, positioned and arranged to allow balanced horizontal and folding movement of the folding slat arrangement along said track assembly between a fully open position and a fully closed position to provide a protective barrier.

2. The accordion shutter system as recited in claim 1 wherein each of said trolleys is connected to a center of the top end of said one of said plurality of slats and each of said central guide pins is attached to a center of the bottom end of each of said plurality of slats for balancing each of said plurality of slats on center between the central gap of said header and said guide slot of said floor track.

3. The accordion shutter system as recited in claim 2 further comprising:
outer abutment surfaces on said header and said floor track; and
contact bushings fitted to and extending from the top and bottom ends of each of said plurality of slats for engaging said outer abutment surfaces.

4. The accordion shutter system as recited in claim 3 wherein said outer abutment surfaces are provided on opposite outboard sides of said header and opposite outboard sides of said floor track.

5. The accordion shutter system as recited in claim 1 wherein said male fittings have a C-shaped cross sectional configuration with opposing curved members terminating at ends to define an open longitudinal gap therebetween.

6. The accordion shutter system as recited in claim 5 wherein said female fittings have a C-shaped cross sectional configuration with opposing curved members terminating at ends to define an open longitudinal gap therebetween.

7. The accordion shutter system as recited in claim 6 wherein said stop members are provided on said ends of said curved members of said male and female fittings.

8. The accordion shutter system as recited in claim 7 wherein combined attachment of said male and female fittings of an adjacently positioned pair of said plurality of slats forms a pin receiving channel for attachment of said contact bushings.

9. The accordion shutter system as recited in claim 8 wherein said stop members are structured and disposed to limit rotation of the interconnected male and female fittings relative to one another about a vertical axis defined along a longitudinal center line of said pin receiving channel.

10. The accordion shutter system as recited in claim 1 further comprising:
said folding slat arrangement including a right side interconnected folding slat arrangement moveably supported on said track assembly, and a left side interconnected folding slat arrangement moveably supported on said track assembly;
a right side center mate slat on an inboard end of said right side interconnected folding slat arrangement;
a left side center mate slat on an inboard end of said left side interconnected folding slat arrangement; and
said right side center mate slat and said left side center mate slat being structured and disposed for releasable joining to one another with said folding slat arrangement in said fully closed position.

11. The accordion shutter system as recited in claim 1 wherein said folding slat arrangement comprises:
at least one end base for anchoring to a fixed surface of a building structure;
a plurality of interconnected full slats; and
at least one starter slat for moveable interconnection between said end base and a first one of said plurality of interconnected full slats.

12. The accordion shutter system as recited in claim 11 wherein said at least one starter slat and said plurality of full slats each include said male and said female fittings along said first and second longitudinal sides, respectively.

13. The accordion shutter system as recited in claim 12 wherein said at least one end base includes said female fitting for cooperative, captured and rotatable receipt of said male fitting on said starter slat.

14. The accordion shutter system as recited in claim 13 wherein said plurality of full slats each include a central pin receiving channel on said top end and said bottom end, and said central pin receiving channel being open at said top and bottom ends for attachment of one of said plurality of said trolleys and said guide pin and bushing, respectively.

15. An accordion shutter system comprising:
a folding slat arrangement including a plurality of interconnecting longitudinal slats each having a top and bottom end, a first longitudinal side extending between said top and bottom ends and an opposite second longitudinal side extending between said top and bottom ends;
a male fitting integrally formed along said first longitudinal side of each of said plurality of slats;
a female fitting integrally formed along said second longitudinal side of each of said plurality of slats and having a C-shaped cross sectional configuration with opposing curved members terminating at ends to define an open longitudinal gap therebetween;
said plurality of slats being moveably interconnected to one another by said male and female fittings, and said male fitting on each of said plurality of slats being structured and disposed for captured, rotating receipt within said female fitting of an adjacently positioned slat, and said male fitting and said female fitting including cooperating stop members for capturing said male fitting within said opposing curved members of said female fitting and for limiting rotational movement of said male fitting relative to said female fitting and thereby limiting folding movement of the plurality of interconnected slats relative to one another;
a track assembly including an upper header and a lower floor track extending parallel with said header along a common plane; and
said folding slat arrangement being moveably supported between said upper header and said lower floor track for allowing balanced horizontal and folding movement of said folding slat arrangement along said track assembly between a fully open position and a fully closed position.

16. The accordion shutter system as recited in claim 15 wherein said folding slat arrangement comprises:
at least one end base for anchoring to a fixed surface of a building structure;
a plurality of interconnected full slats; and
at least one starter slat for moveable interconnection between said end base and a first one of said plurality of interconnected full slats.

17. The accordion shutter system as recited in claim 16 wherein said at least one starter slat and said plurality of full slats each include said male and said female fittings along said first and second longitudinal sides, respectively.

18. The accordion shutter system as recited in claim 17 wherein said at least one end base includes said female fitting for cooperative, captured and rotatable receipt of said male fitting on said starter slat.

19. The accordion shutter system as recited in claim 18 wherein said plurality of full slats each include a central pin receiving channel on said top end and said bottom end, and said central pin receiving channel being open at said top and bottom ends for attachment of a trolley to said top end and a guide pin and bushing to said bottom end, and said trolley being moveably supported within said upper header and said guide pin and bushing being moveably received within a guide slot of said floor track.
